(19) United States
(12) Patent Application Publication
(10) Pub. No.: US 2026/0103058 A1
(43) Pub. Date: Apr. 16, 2026

(54) VEHICLE DOOR ASSEMBLY WITH IMPROVED RIGIDITY

(71) Applicants: HYUNDAI MOTOR COMPANY, Seoul (KR); KIA CORPORATION, Seoul (KR)

(72) Inventor: Je-Won Choi, Hwaseong-si (KR)

(73) Assignees: HYUNDAI MOTOR COMPANY, Seoul (KR); KIA CORPORATION, Seoul (KR)

(21) Appl. No.: 19/193,648

(22) Filed: Apr. 29, 2025

(30) Foreign Application Priority Data
Oct. 11, 2024 (KR) 10-2024-0138403

(51) Int. Cl. B60J 5/04

(52) U.S. Cl. CPC B60J 5/043; B60J 5/0427; B60J 5/0444; B60J 5/0479

(57) ABSTRACT

A vehicle door assembly is constructed with improved rigidity, which ensures sufficient rigidity even without the formation of pillars in a vehicle. The door assembly includes a front door and a rear door, which each include an outer panel and an inner panel coupled to the outer panel. The door assembly further includes an outer member having upper and lower ends coupled to upper and lower ends of the outer panel, respectively, and spaced apart from the outer panel between the upper and lower ends. The door assembly also includes an inner member having upper and lower ends coupled to upper and lower ends of the inner panel, respectively, and spaced apart from the inner panel between the upper and lower ends. The outer member and the inner member are coupled to each other along the height direction of the vehicle. This forms a closed cross-section between the outer member and the inner member.

### CROSS-REFERENCE TO RELATED APPLICATION

This application claims priority to Korean Patent Application No. 10-2024-0138403, filed on Oct. 11, 2024, which is incorporated herein by reference in its entirety.

### BACKGROUND OF THE DISCLOSURE

### Field of the Disclosure

The present disclosure relates to a vehicle door assembly with improved rigidity, which ensures sufficient rigidity in a vehicle with no pillars for the door assembly.

### Description of Related Art

A vehicle door is generally manufactured by processing an outer panel and an inner panel from sheet metal and then joining the outer panel and the inner panel.

As illustrated in FIGS. 1-3, a front door 110 and a rear door 120 are each manufactured by joining respective outer panels 111 and 121 with corresponding inner panels 112 and 122.

Inside the doors 110 and 120, reinforcement members are arranged in the vertical direction of the vehicle and are provided to strengthen the rigidity of the doors 110 and 120.

Specifically, in vehicles that lack a B-pillar connecting a roof portion 131 and a side sill 132 of the vehicle, respective B-pillar beams 113 and 123 are formed in the vertical direction of the vehicle and are arranged between the corresponding outer panels 111 and 121 and the inner panels 112 and 122 at the rear end of the front door 110 and the front end of the rear door 120.

In general, B-pillars in a vehicle may support or absorb a side collision load in the case of a side collision and may support the vehicle's roof in the case of a rollover.

In some vehicles, the B-pillar may be absent for reasons such as ease of passenger entry and exit or to provide a feeling of increased openness. In such cases, the B-pillar beams 113 and 123 are provided at the rear end of the front door 110 and the front end of the rear door 120, respectively, to perform the functions of a B-pillar.

Conventionally, the B-pillar beams 113 and 123 are manufactured in the form of pipes through roll forming and are mounted on the front door 110 and the rear door 120. As illustrated in FIG. 1, the B-pillar beams 113 and 123 are mounted on the front door 110 and the rear door 120, respectively.

However, since the B-pillar beams 113 and 123 are formed to have a uniform cross-sectional shape and diameter along their entire length, there is an issue where the B-pillar beams 113 and 123 are not extended to the upper and lower ends of the front door 110 and the rear door 120.

The gap between the outer panels 111 and 121 and the inner panels 112 and 122 is typically narrow at the upper and lower ends of the front door 110 and the rear door 120. As a result, the B-pillar beams 113 and 123, manufactured with a uniform cross-sectional shape, are not arranged or disposed between the respective outer panels 112 and 121 and inner panels 112 and 122 at the upper and lower ends of the doors.

For example, FIG. 4 illustrates that, at the upper end of the front door 110, due to the installation of an upper latch 133, a space S1 is formed between the lower end of the upper latch 133 and the upper end of the B-pillar beam 113. In addition, FIG. 5 illustrates that, at the lower end of the front door 110, a space S2 is formed between the lower end of the B-pillar beam 113 and the side sill 132.

Because of the limited space inside the doors 110 and 120, the upper and lower ends of the B-pillar beams 113 and 123 are not connected to the doors 110 and 120, leading to a decrease in rigidity.

Referring to FIG. 1, in order to install the B-pillar beams 113 and 123 in the doors 110 and 120, reinforcements 117A, 117B, 117C, 127A, 127B, and 127C are used. Thermal deformation occurs during the welding of the B-pillar beams 113 and 123 to the reinforcements 117A, 117B, 117C, 127A, 127B, and 127C and occurs during the welding of the reinforcements 117A, 117B, 117C, 127A, 127B, and 127C to the doors 110 and 120.

Moreover, in order to increase the rigidity of the B-pillar beams 113 and 123, the cross-sectional area of the B-pillar beams 113 and 123 needs to be increased. However, when the B-pillar beams 113 and 123 are manufactured using roll forming, it is difficult to vary the cross-sectional area in different portions, making it challenging to increase the rigidity.

As also shown in FIG. 1, the reference numbers 116 and 126 refer to door impact beams and reference number 125 refers to a side wall panel that connects the front ends of the outer panel 121 and the inner panel 122 in the rear door 120.

### SUMMARY

Various aspects of the present disclosure are directed to providing a vehicle door assembly with improved rigidity. An outer member and an inner member of the door assembly have different cross-sections for each section and the outer member and the inner member are joined to each other to have a closed cross-section.

An object of the present disclosure is to provide a vehicle door assembly with improved rigidity via closed cross-sections. A primary closed cross-section is formed by the outer member and the inner member and the inner member forms a secondary closed cross-section with the inner panel of the door. This improves rigidity through the double closed cross-sections.

Another object of the present disclosure is to provide a vehicle door assembly with improved rigidity via door overlap. The outer member and the inner member overlap with an adjacent door or another outer member and inner member. This prevents the front door and the rear door from jamming against each other in the case of collision.

Yet another object of the present disclosure is to provide a vehicle door assembly with improved rigidity via the upper and lower ends of the outer member and the inner member being connected to the upper and lower ends of the door of the vehicle.

A vehicle door assembly with improved rigidity according to an embodiment of the present disclosure, intended to achieve the above-described objects, includes a front door and a rear door, each including an outer panel and an inner panel coupled to the outer panel. The vehicle door assembly further includes an outer member having upper and lower ends coupled to upper and lower ends of the outer panel, respectively, and spaced apart from the outer panel between the upper and lower ends. The vehicle door assembly also includes an inner member having upper and lower ends coupled to upper and lower ends of the inner panel, respectively, and spaced apart from the inner panel between the upper and lower ends. The outer member and the inner member are coupled to each other along the height direction of the vehicle. This forms a closed cross-section between the outer member and the inner member.

The outer member may be formed with a cross-section that is open toward the inner panel. The inner member may be formed with a cross-section open toward the outer panel. The outer member and the inner member may be coupled to each other at both ends in a longitudinal direction of the vehicle.

The outer member or the inner member may be coupled to the respective outer panel or inner panel along the height direction of the vehicle, so that another closed cross-section is formed between the inner member and the inner panel.

The vehicle door assembly may further includes a side wall panel configured to connect a front end of the outer panel with a front end of the inner panel of the rear door. In the rear door, the front ends of the outer member and the inner member may be coupled to each other and coupled to the side wall panel.

The outer member and the inner member may each be formed by pressing a metal sheet, i.e., sheet metal.

The outer member and the inner member may each be formed by hot stamping a steel sheet.

The outer member may include a main body portion disposed along the height direction of the vehicle, a flange portion coupled to the inner member, and an extension portion extending from the main body portion to the flange portion. This connects the main body portion with the flange portion.

To align coupling positions when the outer member and the inner member are coupled, a forming portion may be convexly or concavely provided along the height direction of the vehicle on the flange portion.

The inner member may include a main body portion disposed along the height direction of the vehicle, a flange portion coupled to the inner member, and an extension portion extending from the main body portion to the flange portion. This connects the main body portion with the flange portion.

To align coupling positions when the outer member and the inner member are coupled, a forming portion may be convexly or concavely provided along the height direction of the vehicle on the flange portion.

The outer member may be formed to be spaced from the outer panel with a variable gap along the height direction of the vehicle.

The inner member may be formed to be spaced from the inner panel with a variable gap along the height direction of the vehicle.

The outer member and the inner member may each be formed with a predetermined thickness along the height direction of the vehicle.

A portion where the outer member and the inner member are coupled in the front door may be positioned farther outward on the vehicle than a portion where the outer member and the inner member are coupled in the rear door.

A rear end of a portion where the outer member and the inner member are coupled in the front door may overlap in the longitudinal direction of the vehicle with a portion where the inner member and the inner panel are coupled in the rear door.

An upper end of the outer member may be positioned higher than an upper latch, which is installed at an upper portion of the front door or the rear door.

An upper end of the outer member or an upper end of the inner member may be positioned higher than a lower end of a roof portion of the vehicle. Thus, the upper end of the outer member or the upper end of the inner member may overlap with the lower end of the roof portion along the height direction of the vehicle.

A lower end of the outer member or a lower end of the inner member may be positioned lower than an upper end of a side sill of the vehicle. Thus, the lower end of the outer member or the lower end of the inner member may overlap with the upper end of the side sill along the height direction of the vehicle.

The outer member may have a gradually varying cross-section where a height of the main body portion of the outer member varies along the height direction of the vehicle.

The vehicle door assembly of the present disclosure, having the configuration described above, rigidity is improved by the outer member and inner member being formed to have different cross-sectional shapes for each section along the height direction of the vehicle, and by joining these outer member and inner member to form a closed cross-section.

In particular, since the outer member and inner member have different cross-sectional shapes for each section, the front door and rear door each have a closed cross-sectional structure formed at the upper and lower ends. By applying this to the rear end of the front door and the front end of the rear door, rigidity of the vehicle's side is improved even in vehicles that do not have a B-pillar.

In addition, the inner member has a double closed cross-section with the inner panel of the door, enabling further improvement in rigidity.

Furthermore, the upper and lower ends of the outer member and the inner member are respectively connected to the door. This improves the connection rigidity between the upper and lower ends of the door and the vehicle body.

The outer member and the inner member overlap with an adjacent door or another outer member and inner member installed in an adjacent door. This prevents the front door and the rear door from jamming against each other in the case of a collision.

### BRIEF DESCRIPTION OF THE DRAWINGS

FIG. 1 is a schematic view illustrating a front door and a rear door of a vehicle, not having a B-pillar, according to the related art.

FIG. 2 is a cross-sectional view taken along line I-I in FIG. 1.

FIG. 3 is a cross-sectional view taken along line II-II in FIG. 1.

FIG. 4 is a schematic view illustrating the positional relationship between a B-pillar beam and an upper latch shown in portion A of FIG. 1.

FIG. 5 is a schematic view illustrating the positional relationship between the B-pillar beam and a side sill shown in portion B of FIG. 1.

FIG. 6 is a schematic view illustrating a vehicle door assembly according to the present disclosure.

FIG. 7 is an exploded perspective view illustrating an outer member and an inner member respectively arranged at a rear end of a front door and a front end of a rear door in a vehicle door assembly according to the present disclosure.

FIG. 8 is a cross-sectional view taken along line III-III in FIG. 6.

FIG. 9 is a cross-sectional view taken along line IV-IV in FIG. 6.

FIG. 10A is a cross-sectional view illustrating an example of a cross-section of an outer member and an inner member mounted on a front door in a vehicle door assembly according to the present disclosure.

FIG. 10B is a cross-sectional view illustrating an example of a cross-section of an outer member and an inner member mounted on a rear door in a vehicle door assembly according to the present disclosure.

FIG. 11 is a perspective view illustrating forming portions on an outer member and an inner member in a vehicle door assembly according to the present disclosure.

FIG. 12 is a perspective view illustrating a gradually varying section of an outer member in a vehicle door assembly according to the present disclosure.

FIG. 13 is a cross-sectional view illustrating a state in which an outer member and an inner member of a front door are overlapping with a rear door or with an outer member and inner member of the rear door at upper portions of the front door and the rear door in a vehicle door assembly according to the present disclosure.

FIG. 14 is a cross-sectional view illustrating a state in which an outer member and an inner member of a front door overlap with a rear door or with an outer member and inner member of the rear door at lower portions of the front door and the rear door in a vehicle door assembly according to the present disclosure.

FIG. 15 is a cross-sectional view illustrating a state in which an upper end of an outer member and an upper end of an inner member are overlapped with an upper end of an outer panel and an upper end of an inner panel, respectively, in a vehicle door assembly according to the present disclosure.

FIG. 16 is a cross-sectional view illustrating a state in which an outer member of a front door covers an upper latch in a vehicle door assembly according to the present disclosure.

FIG. 17 is a cross-sectional view illustrating a state in which a lower end of an outer member and a lower end of an inner member are overlapped with a side sill in a vehicle door assembly according to the present disclosure.

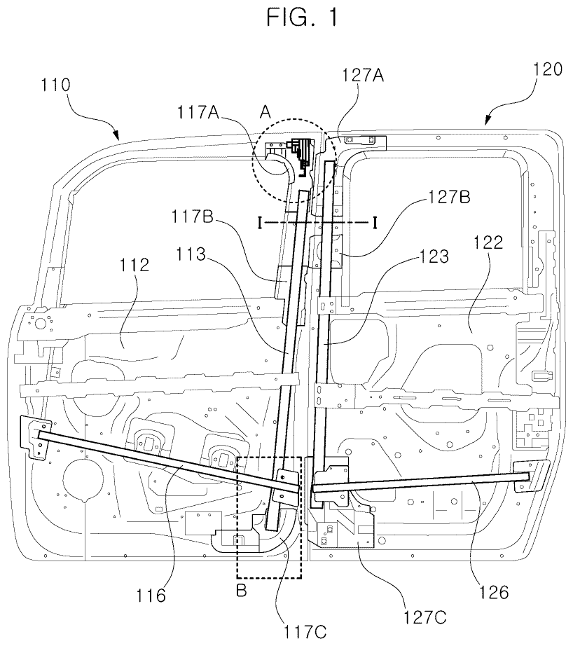

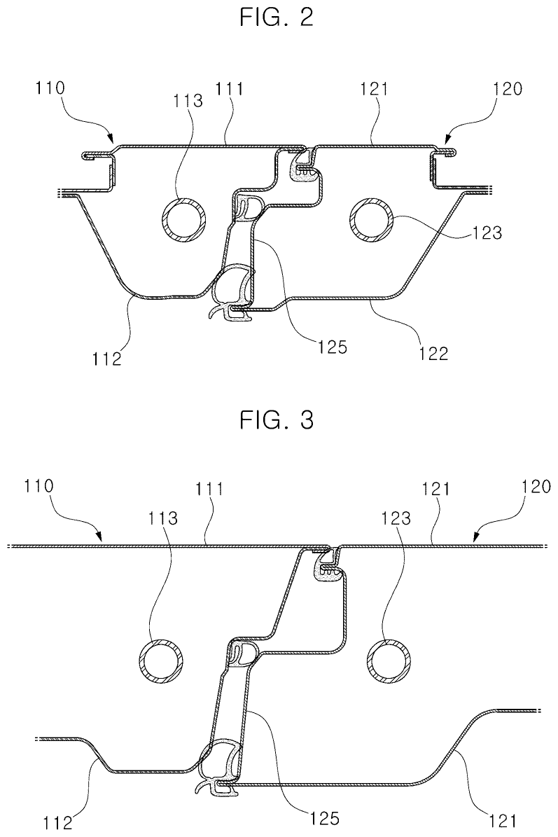

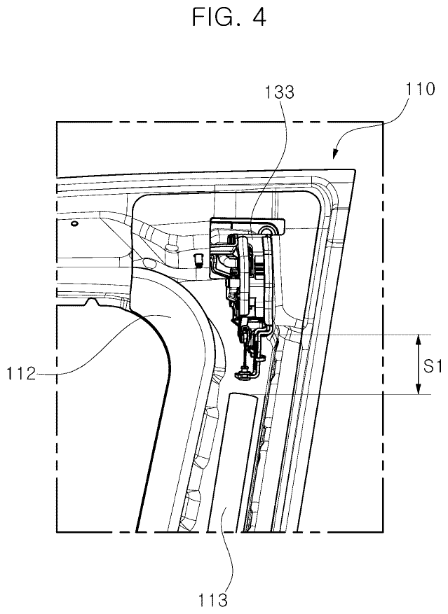

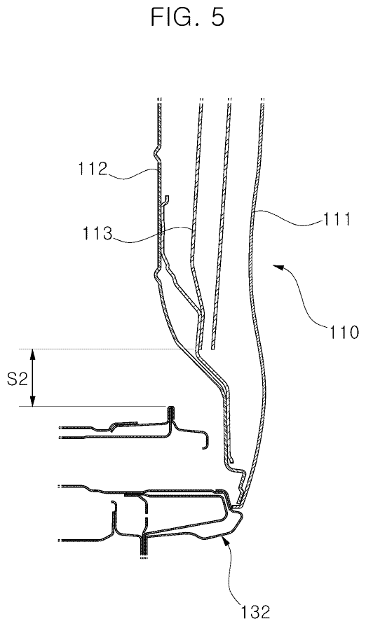

### DESCRIPTION OF SPECIFIC EMBODIMENTS

A vehicle door assembly with improved rigidity according to the present disclosure will be described hereinafter in detail with reference to the accompanying drawings.

Some embodiments of the present disclosure are described in detail with reference to the accompanying drawings. In the following description, like reference numerals designate like elements, even when the elements are shown in different drawings. Further, in the following description of some embodiments, a detailed description of known functions and configurations incorporated therein has been omitted for the purpose of clarity and for brevity.

When a component, device, member, assembly, apparatus or the like of the present disclosure is described as having a purpose or performing an operation, function, or the like, the component, device, member, assembly, or apparatus should be considered herein as being “configured to” meet that purpose or to perform that operation or function. Further, as used herein, the term “formed” and variations thereof may mean the process of manufacturing or forming the noted aspect of the door assembly, or may mean that the noted aspect is disposed, provided, or positioned as described.

The vehicle door assembly with improved rigidity according to the present disclosure includes a front door 10 and a rear door 20, which respectively include outer panels 11 and 21 and inner panels 12 and 22 that are coupled to the outer panels 11 and 21. The vehicle door assembly further includes outer members 13 and 23 having upper and lower ends coupled to upper and lower ends of the outer panels 11 and 21, respectively, and spaced apart from the outer panels 11 and 21 between the upper and lower ends. The door assembly also includes inner members 14 and 24 having upper and lower ends coupled to upper and lower ends of the inner panels 12 and 22, respectively, and spaced apart from the inner panels 12 and 22 between the upper and lower ends. The outer members 13 and 23 and the respective inner members 14 and 24 are coupled to each other along the height direction of the vehicle. This forms a closed cross-section between the outer members 13 and 23 and the inner members 14 and 24.

The front door 10 and the rear door 20 of the vehicle are each formed by respectively joining the outer panels 11 and 21 and the inner panels 12 and 22 with each other.

Between the outer panels 11 and 21 and the inner panels 12 and 22, devices such as a door glass, a regulator for operating the door glass, a speaker or the like may be installed. A trim piece may be mounted on the inner panels 12 and 22 to finish the inner surface of the front door 10 and the rear door 20.

In most vehicles, a B-pillar is used in the vehicle to connect a roof portion 31 of the vehicle with a side sill 32 and to support a rear end of the front door 10 and a front end of the rear door 20.

However, in some vehicles, the B-pillar is not provided between the roof portion 31 and the side sill 32 for reasons such as ease of passenger entry and exit and for providing a feeling of openness.

As such, in vehicles without the B-pillar, it is necessary to provide structure and support in the event of a side collision load to prevent the front door 10 and rear door 20 from intruding into the vehicle's interior in the case of a side collision. In addition, in the case of a rollover of the vehicle, it is necessary to support the vehicle's roof to protect the passengers. Even if the B-pillar is not provided, the front door 10 and rear door 20 should exhibit performance equivalent to that of a vehicle with a B-pillar. This is regulated by various laws and regulations, and those laws and regulations are gradually becoming more strict or stringent.

The present disclosure applies reinforcement structures, including the outer members 13 and 23 and the inner members 14 and 24, to the front door 10 and the rear door 20 to improve the rigidity of the front door 10 and the rear door 20. Due to the reinforcement structure formed by the outer members 13 and 23 and the inner members 14 and 24 in the front door 10 and the rear door 20, the rigidity at the sides of the vehicle is improved.

For example, at the rear end of the front door 10, the outer member 13 and the inner member 14 are provided between the outer panel 11 and the inner panel 12 that constitute the front door 10. Thus, the outer member 13 and the inner member 14 form a closed cross-section C1, i.e., a first or primary closed cross-section.

The upper and lower ends of the outer member 13 are coupled to the upper and lower ends of the outer panel 11 on the inner surface of the outer panel 11, respectively. The outer member 13 is spaced apart from the outer panel 11, except at the upper and lower ends, i.e., between the upper and lower ends of the outer member 13.

The upper and lower ends of the inner member 14 are also coupled to the upper and lower ends of the inner panel 12 on the inner surface of the inner panel 12, respectively. In addition, the inner member 14 is spaced apart from the inner panel 12, except at the upper and lower ends, i.e., between the upper and lower ends of the inner member 14.

The outer member 13 is formed with a cross-section that is open toward the inner member 14. The inner member 14 is formed with a cross-section that is open toward the outer member 13.

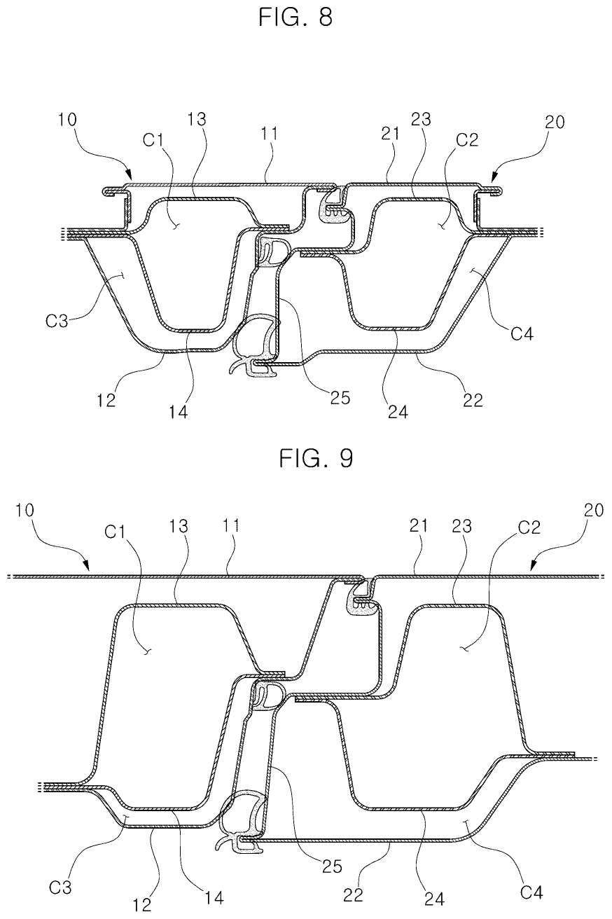

The outer member 13 and the inner member 14 are coupled to each other at both ends in the longitudinal direction of the vehicle. Referring to FIGS. 8 and 9, the outer member 13 and the inner member 14 are coupled to each other at both ends in the longitudinal direction of the vehicle (right-left direction in FIGS. 8 and 9).

The outer member 13 and the inner member 14 are coupled to each other at both ends in order to form the closed cross-section C1 between the outer member 13 and the inner member 14.

By forming a closed cross-section with the outer member 13 and the inner member 14 between the outer panel 11 and the inner panel 12, the rigidity of the rear end of the front door 10 is improved.

In addition, the outer member 13 or the inner member 14 is coupled to the outer panel 11 or the inner panel 12. Thus, another closed cross-section C3, i.e., a second, additional, or secondary closed cross-section is formed between the inner member 14 and the inner panel 12.

By forming closed cross-sections C1 and C3 in a double layer at the rear end of the front door 10, the rigidity is further improved.

At the front end of the rear door 20, similar to the rear end of the front door 10, the outer member 23 and the inner member 24 are provided to improve the rigidity of the front end of the rear door 20.

The rear door 20 is also formed by coupling the outer panel 21 and the inner panel 22. The outer member 23 and the inner member 24 are provided between the outer panel 21 and the inner panel 22. Thus, a closed cross-section C2, i.e., a first or primary closed cross-section is formed by the outer member 23 and the inner member 24. The front end of the outer panel 21 and the front end of the inner panel 22 of the rear door 20 may be directly coupled to each other. However, in one example, the front ends of the outer panel 21 and the inner panel 22 are coupled using a side wall panel 25. In this case, the front end of the outer panel 21 and the front end of the inner panel 22 are coupled through hemming or welding.

Similar to the outer member 13, the upper and lower ends of the outer member 23 are coupled to the upper and lower ends of the outer panel 21 on the inner surface of the outer panel 21, respectively. The outer member 23 is spaced apart from the outer panel 21, except at the upper and lower ends, i.e., between the upper and lower ends of the outer member 23.

The upper and lower ends of the inner member 24 are also coupled to the upper and lower ends of the inner panel 22 on the inner surface of the inner panel 22, respectively. In addition, the inner member 24 is spaced apart from the inner panel 22, except at the upper and lower ends, i.e., between the upper and lower ends of the inner member 24.

The outer member 23 and the inner member 24 are also formed with cross-sections that are open toward each other.

The outer member 23 and the inner member 24 are coupled to each other at both ends in the longitudinal direction of the vehicle. This forms the closed cross-section C2 between the outer member 23 and the inner member 24.

Referring to FIGS. 8 and 9, the outer member 23 and the inner member 24 are coupled to each other at both ends in the longitudinal direction of the vehicle. This forms a closed cross-section therebetween. By forming a closed cross-section with the outer member 23 and the inner member 24 between the outer panel 21 and the inner panel 22, the rigidity of the rear end of the rear door 20 is improved.

In addition, in the rear door 20, the outer member 23 or the inner member 24 is directly or indirectly coupled to the outer panel 21 or the inner panel 22. Thus, another closed cross-section C4, i.e., a second, additional, or secondary closed cross-section is formed between the inner member 24 and the inner panel 22. For example, in the rear door 20, the front ends of the outer member 23 and the inner member 24 are coupled to each other and coupled to the side wall panel 25. The rear ends of the outer member 23 and the inner member 24 are coupled to each other and directly coupled to the inner panel 24. In other words, the front end of the outer member 23 and the front end of the inner member 24 are coupled to each other and connected to the outer panel 21 and the inner panel 22 through the side wall panel 25. Thus, the closed cross-section C4 is formed between the inner member 24 and the inner panel 22.

Double closed cross-sections C2 and C4 are also formed at the front end of the rear door 20, thereby providing further improved rigidity.

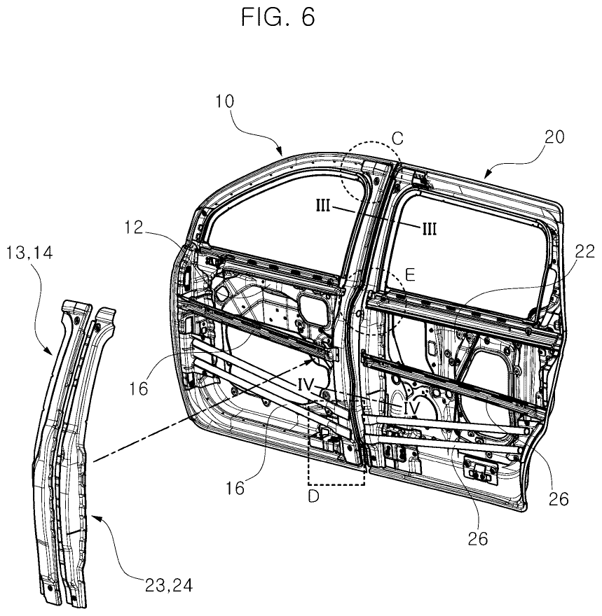

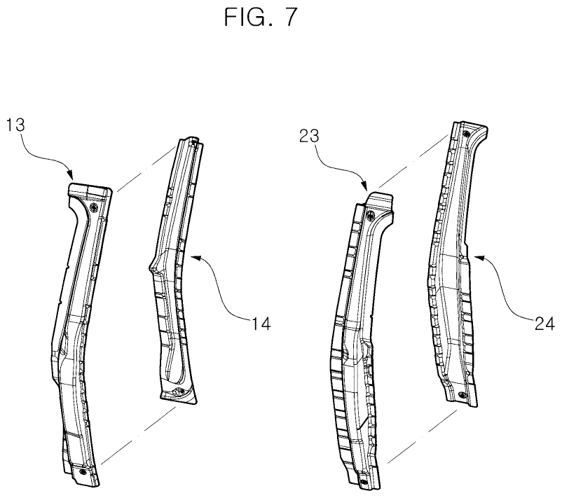

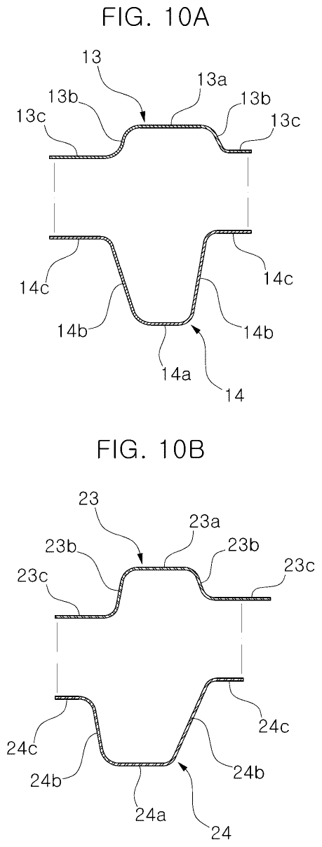

In the cross-sections, the outer members 13 and 23 and the inner members 14 and 24 are formed with a convex or concave shape to facilitate achieving adequate or sufficient rigidity. Also, flange shapes are formed at both ends to enable easy coupling through welding or similar methods. FIGS. 10A and 10B illustrate an example of the cross-sections of the outer members 13 and 23 and the inner members 14 and 24 at an upper portion of a belt portion of the front door 10 and the rear door 20 (indicated by the line III-III in FIG. 6).

For example, the outer members 13 and 23 are configured to include main body portions 13a and 23a formed along the height direction of the vehicle, flange portions 13c and 23c coupled to the inner members 14 and 24, and extension portions 13b and 23b extending from the main body portions 13a and 23a to the flange portions 13c and 23c. Thus, the main body portions 13a and 23a are connected with the flange portions 13c and 23c.

The main body portions 13a and 23a are spaced apart from the outer panels 11 and 21 between the upper and lower ends thereof.

The flange portions 13c and 23c are coupled to the inner members 14 and 24.

The extension portions 13b and 23b connect the main body portions 13a and 23a with the flange portions 13c and 23c. Thus, a cross-sectional structure is formed in which the outer members 13 and 23 are open toward the inner members 14 and 24.

The inner members 14 and 24 are configured to include main body portions 14a and 24a formed along the height direction of the vehicle, flange portions 14c and 24c coupled to the inner members 14 and 24, and extension portions 14b and 24b extending from the main body portions 14a and 24a to the flange portions 14c and 24c. Thus, the main body portions 14a and 24a are connected with the flange portions 14c and 24c.

The main body portions 14a and 24a are spaced apart from the inner panels 12 and 22 between the upper and lower ends thereof.

The flange portions 14c and 24c are coupled to the flange portions 13c and 23c of the outer members 13 and 23, respectively. Thus, the outer members 13 and 23 and the inner members 14 and 24 form a single structure.

The extension portions 14b and 24b connect the main body portions 14a and 24a with the flange portions 14c and 24c. Thus, a cross-sectional structure is formed in which the inner members 14 and 24 are open toward the outer members 13 and 23.

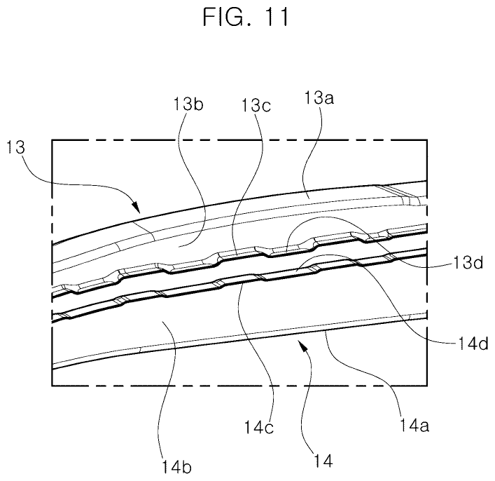

To align the coupling positions when the outer members 13 and 23 and the inner members 14 and 24 are coupled, a forming portion 13d is convexly or concavely formed along the height direction of the vehicle on the flange portions 13c and 23c. Also, a forming portion 14d is convexly or concavely formed along the height direction of the vehicle on the flange portions 14c and 24c. In other words, FIG. 11 illustrates an example in which the forming portion 13d is concavely formed at intervals on the flange portion 13c of the outer member 13. Also, the forming portion 14d is convexly formed at intervals on the flange portion 14c of the inner member 14. A concave-convex structure is formed by the forming portion 13d of the outer member 13 and the forming portion 14d of the inner member 14. This facilitates easy alignment of the coupling position.

The outer member 13 and the inner member 14 utilize the forming portions 13d and 14d to facilitate the alignment of the flange portion 13c of the outer member 13 and the flange portion 14d of the inner member 14 to predetermined positions. In this aligned state, with the flange portions 13c and 23c of the outer member 13 and the flange portions 14c and 24c of the inner member 14 in contact, the outer member 13 and the inner member 14 may be coupled together through spot welding or similar methods.

Once the outer member 13 and the inner member 14 become a single assembly through welding or similar methods, the assembly is coupled to the inner panel 12. Welding may also be used when coupling the assembly of the outer member 13 and the inner member 14 to the inner panel 12. The assembly of the outer member 13 and the inner member 14 may also be coupled to the outer panel 13.

In the rear door 20, the forming portion may also be formed on the outer member 23 and the inner member 24.

The cross-section of the outer members 13 and 23 and the inner members 14 and 24 at a lower portion of the belt portion of the front door 10 and the rear door 20 may differ slightly in detailed form. However, the main body portions 13a, 14a, 23a, 24a, the flange portions 13c, 14c, 23c, 24c, and the extension portions 13b, 14b, 23b, 24b are also formed thereon. The forming portion may be also formed.

The outer members 13 and 23 and the inner members 14 and 24 are each formed with a variable cross-section along the height direction of the vehicle.

To achieve this, the outer members 13 and 23 and the inner members 14 and 24 are each formed by pressing a metal sheet, i.e., sheet metal. Specifically, the outer members 13 and 23 and the inner members 14 and 24 are each formed by hot stamping a steel sheet.

Conventionally, B-pillar beams 13 and 23 are manufactured by roll forming, so the entire section of the B-pillar beams 13 and 23 is only formed with the same cross-sectional shape. However, in the present disclosure, the outer members 13 and 23 and the inner members 14 and 24 are manufactured by hot stamping, allowing the outer members 13 and 23 and the inner members 14 and 24 to be formed with a variable cross-section along their length direction, i.e., the vehicle's height direction.

Since the cross-section of the outer members 13 and 23 may vary along the height direction of the vehicle, the outer members 13 and 23 may be formed to be spaced from the outer panel 11 and 21 with a variable gap along the height direction of the vehicle. For example, the outer members 13 and 23 may be formed to be spaced from the outer panels 11 and 21, with a narrow gap at the upper and lower portions and a wider gap at the middle portion. Similarly, the inner members 14 and 24 may be formed to be spaced from the inner panels 12 and 22 with a variable gap along the height direction of the vehicle.

In this way, when the outer members 13 and 23 and the inner members 14 and 24 are formed to be spaced from the outer panels 11 and 21 and the inner panels 12 and 22 with variable gaps in each section, the sizes of the closed cross-sections C1 and C2 formed between the outer members 13 and 23 and the inner members 14 and 24 may vary.

Accordingly, in areas where the gap between the outer panel 11 and 21 and the inner panel 12 and 22 is narrow, such as at the upper portion of the belt portion of the doors 10 and 20, the cross-sectional area of the closed cross-sections C1 and C2 formed by the outer members 13 and 23 and the inner members 14 and 24 may be narrowed or narrower (see FIG. 8). At the lower portion of the belt portion, the cross-sectional area of the closed cross-sections C1 and C2 may be formed to meet the required performance (see FIG. 9).

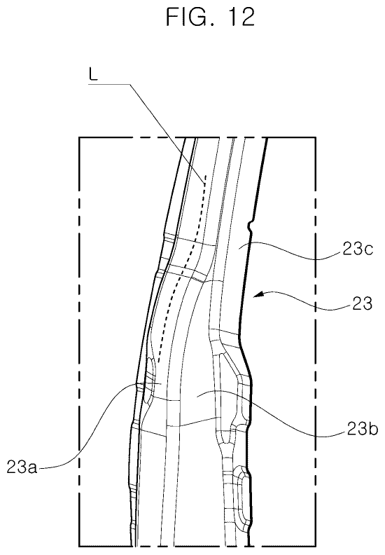

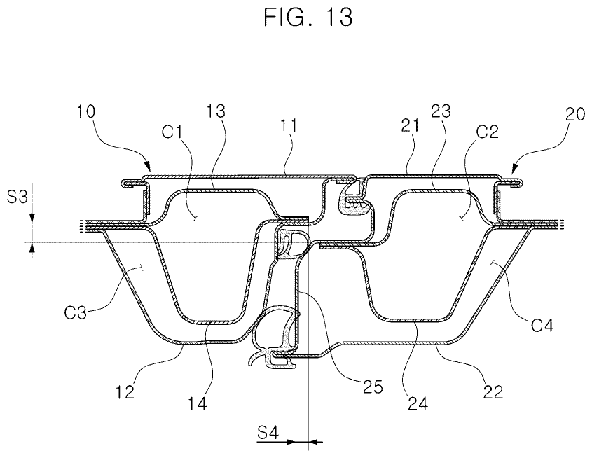

Since the outer members 13 and 23 and the inner members 14 and 24 may be formed into the desired shape, a gradually varying section L, where the cross-section gradually varies, may be formed in the belt portion of the doors 10 and 20. In other words, referring to FIG. 12, in the gradually varying section L, the height of the main body portions 13a and 23a of the outer members 13 and 23 varies along the height direction of the vehicle so that the height thereof increases as it goes downward. As the space between the outer panels 11 and 21 and the inner panels 12 and 22 widens at the lower portion of the belt portion, the gradually varying section L may be formed such that the cross-sectional area of the outer members 13 and 23 and the inner members 14 and 24 increases.

Furthermore, the outer members 13 and 23 and the inner members 14 and 24 may each be formed with a predetermined thickness along the height direction of the vehicle. Accordingly, the outer members 13 and 23 and the inner members 14 and 24 may have a different thickness along their length direction. In other words, areas of the outer members 13 and 23 and the inner members 14 and 24 where high collision performance is required may be formed having a greater thickness than other areas. For example, in the case of a side collision, the thickness of the areas where side collision loads may be expected to occur may be increased. This allows these areas to more sturdily support or absorb the collision load.

In the front door 10, the portion where the outer member 13 and the inner member 14 are coupled is positioned farther outward (relative to a lengthwise centerline of the vehicle) on the vehicle than the portion where the outer member 23 and the inner member 24 are coupled in the rear door 20.

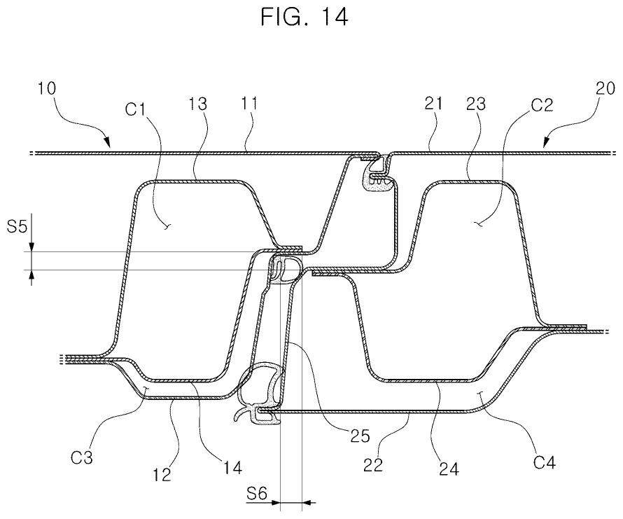

Referring to FIGS. 13 and 14, it may be seen that the portion where the outer member 13 and the inner member 14 are coupled in the front door 10 is positioned farther outward on the vehicle by the size of S3 and S5 than the portion where the outer member 23 and the inner member 24 are coupled in the rear door 20.

Accordingly, in the case of a side collision, the collision load is supported or absorbed to prevent the rear end of the front door 10 or the front end of the rear door 20 from intruding into the interior of the vehicle.

In addition, the rear end of the portion where the outer member 13 and the inner member 14 are coupled in the front door 10 overlaps in the longitudinal direction of the vehicle with the portion where the inner member 24 and the inner panel 22 are coupled in the rear door 20.

In other words, as illustrated in FIGS. 13 and 14, the portion where the outer member 13 and the inner member 14 are coupled in the front door 10 overlaps, by the size of S4 and S6, with the portion where the inner member 24 and the inner panel 22 are coupled in the rear door 20.

Accordingly, when an external load is applied due to a collision, the rear end of the front door 10 and the front end of the rear door 20 are prevented from jamming against each other. This allows the front door 10 and the rear door 20 to be opened even in the case of collision.

The outer members 13 and 23 and the inner members 14 and 24 are extended more at the upper and lower portions compared to the conventional configuration. Thus, the connection rigidity between the doors 10 and 20 and the vehicle body is improved.

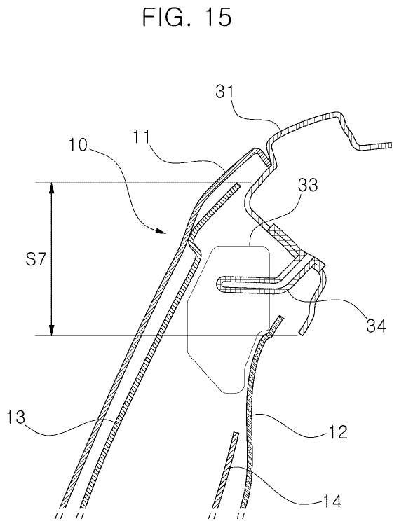

The upper end of the outer member 13 extends to be coupled with the upper end of the outer panel 11 at the rear end of the front door 10. Thus, the upper end of the outer member 13 overlaps with the lower end of the roof portion 31 by a predetermined height S7. In other words, referring to FIG. 15, the upper end of the outer member 13 is positioned higher than the lower end of the roof portion 31 where a striker 34 is installed. This results in the outer member 13 and the roof portion 31 overlapping with each other by a certain height S7. This improves the connection rigidity between the front door 10 and the roof portion 31. In addition, the upper end of the inner member 14 also extends to be coupled to the upper end of the inner panel 12. In the front door 10, the upper ends of the outer member 13 and the inner member 14 are positioned higher than the lower end of the roof portion 31, overlapping along the height direction of the vehicle. This improves the connection rigidity between the front door 10 and the roof portion 31.

In addition, in the portion where the upper latch 33 is formed in the front door 10, the upper end of the inner member 14 extends up to the upper end of the inner panel 12 to wrap around the upper latch 33. In other words, in the front door 10, the upper end of the outer member 13 is positioned higher than the upper latch 33, which is installed at the upper portion of the front door 10.

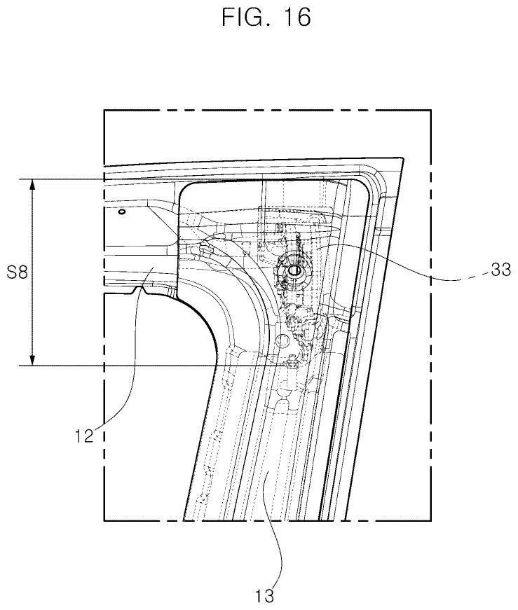

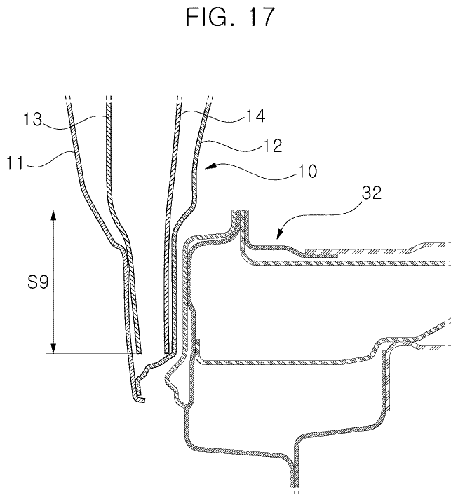

Conventionally, in the portion where the upper latch is installed, space was limited, so the B-pillar beam on the door is only applied up to the lower portion of the upper latch. However, in the present disclosure, the inner member 14 may be extended farther by the size of a section S8 to wrap around the upper latch 33 (see FIG. 16). This improves the connection rigidity between the front door 10 and the vehicle body at the upper portion thereof.

At the rear end of the front door 10, the lower ends of the outer member 13 and the inner member 14 extend to the lower ends of the outer panel 11 and the inner panel 12. Thus, the outer member 13 and the inner member 14 overlap with the side sill 32 by a certain height S9 (see FIG. 17). In other words, the lower end of the outer member 13 or the lower end of the inner member 14 is positioned lower than the upper end of the side sill 32. Thus, the lower end of the outer member 13 or the lower end of the inner member 14 overlaps with the upper end of the side sill 32 along the height direction of the vehicle. Accordingly, the connection rigidity between the front door 10 and the vehicle body is improved even at the lower end of the front door 10.

The improved connection rigidity with the vehicle body at the rear end of the front door 10 is provided by the outer member 13 and the inner member 14 at both the upper and lower portions of the front door 10 and thus may also be achieved between the rear door 20 and the vehicle body.

Specifically, in the rear door 20 as well, the upper end of the outer member 23 or the upper end of the inner member 24 is positioned higher than the lower end of the roof portion 31. Thus, the upper end of the outer member 23 or the upper end of the inner member 24 overlaps with the lower end of the roof portion 31 along the height direction of the vehicle.

If an upper latch is installed in the rear door 20 as well, the upper end of the outer member 23 in the rear door 20 is also positioned higher than the upper latch 33 in the area where the upper latch 33 is installed.

In addition, in the front end of the rear door 20, the lower end of the outer member 23 or the lower end of the inner member 24 is positioned lower than the upper end of the side sill 32. This causes the lower end of the outer member 23 or the inner member 24 to overlap with the upper end of the side sill 32 in the height direction of the vehicle.

The undescribed reference numbers 16 and 26 refer to door impact beams on the front and rear doors 10 and 20, respectively.

Although example embodiments of the present disclosure have been described for illustrative purposes, those of ordinary skill in the art should appreciate that various modifications, additions, and substitutions are possible without departing from the spirit and scope of the claims. Therefore, example embodiments of the present disclosure have been described for the sake of brevity and clarity. The scope of the technical concepts of the present disclosure is not limited by the illustrations and embodiments. Accordingly, one of ordinary skill should understand that the scope of the claims is not to be limited by the above explicitly described embodiments but by the claims and equivalents thereof.

What is claimed is:

1. A vehicle door assembly comprising:
a front door and a rear door, each of which include an outer panel and an inner panel coupled to the outer panel, wherein the vehicle door assembly further includes
an outer member having upper and lower ends coupled to upper and lower ends of the outer panel, respectively, the outer member spaced apart from the outer panel between the upper and lower ends, and
an inner member having upper and lower ends coupled to upper and lower ends of the inner panel, respectively, the inner member spaced apart from the inner panel between the upper and lower ends, and
wherein the outer member and the inner member are coupled to each other along a height direction of the vehicle forming a closed cross-section between the outer member and the inner member.

2. The vehicle door assembly of claim 1, wherein the outer member has a cross-section open toward the inner panel, wherein the inner member has a cross-section open toward the outer panel, and wherein the outer member and the inner member are coupled to each other at both ends in a longitudinal direction of the vehicle.

3. The vehicle door assembly of claim 1, wherein the outer member or the inner member is coupled to the outer panel or the inner panel along the height direction of the vehicle, so that another closed cross-section is formed between the inner member and the inner panel.

4. The vehicle door assembly of claim 3, further comprising
a side wall panel connecting a front end of the outer panel with a front end of the inner panel of the rear door,
wherein, in the rear door, the front ends of the outer member and the inner member are coupled to each other and coupled to the side wall panel.

5. The vehicle door assembly of claim 1, wherein the outer member and the inner member are each formed of a pressed metal sheet.

6. The vehicle door assembly of claim 5, wherein the outer member and the inner member are each formed of a hot stamped steel sheet.

7. The vehicle door assembly of claim 1, wherein the outer member comprises:
a main body portion disposed along the height direction of the vehicle;
a flange portion coupled to the inner member; and
an extension portion extending from the main body portion to the flange portion and connecting the main body portion with the flange portion.

8. The vehicle door assembly of claim 7, wherein a forming portion is convexly or concavely provided along the height direction of the vehicle on the flange portion to align coupling positions when the outer member is coupled with the inner member.

9. The vehicle door assembly of claim 1, wherein the inner member comprises:
a main body portion disposed along the height direction of the vehicle;
a flange portion coupled to the inner member; and
an extension portion extending from the main body portion to the flange portion and connecting the main body portion with the flange portion.

10. The vehicle door assembly of claim 9, wherein a forming portion is convexly or concavely provided along the height direction of the vehicle on the flange portion to align coupling positions when the outer member is coupled with the inner member.

11. The vehicle door assembly of claim 1, wherein the outer member is spaced from the outer panel with a variable gap along the height direction of the vehicle.

12. The vehicle door assembly of claim 1, wherein the inner member is spaced from the inner panel with a variable gap along the height direction of the vehicle.

13. The vehicle door assembly of claim 1, wherein the outer member and the inner member each have a predetermined thickness along the height direction of the vehicle.

14. The vehicle door assembly of claim 1, wherein a portion, where the outer member and the inner member are coupled in the front door, is positioned farther outward on the vehicle than a portion where the outer member and the inner member are coupled in the rear door.

15. The vehicle door assembly of claim 1, further comprising:
a first portion where the outer member and the inner member are coupled in the front door; and
a second portion where the inner member and the inner panel are coupled in the rear door,
wherein a rear end of the first portion overlaps with the second portion in a longitudinal direction of the vehicle.

16. The vehicle door assembly of claim 1, wherein an upper end of the outer member is positioned higher than an upper latch, which is installed at an upper portion of the front door or the rear door.

17. The vehicle door assembly of claim 1, wherein an upper end of the outer member or an upper end of the inner member is positioned higher than a lower end of a roof portion of the vehicle, so that the upper end of the outer member or the upper end of the inner member overlaps with the lower end of the roof portion along the height direction of the vehicle.

18. The vehicle door assembly of claim 1, wherein a lower end of the outer member or a lower end of the inner member is positioned lower than an upper end of a side sill of the vehicle, so that the lower end of the outer member or the lower end of the inner member overlaps with the upper end of the side sill along the height direction of the vehicle.

19. The vehicle door assembly of claim 1, wherein the outer member has a gradually varying cross-section where a height of a main body portion of the outer member varies along the height direction of the vehicle.
